(19) United States
(12) Patent Application Publication
(10) Pub. No.: US 2018/0273422 A1
(43) Pub. Date: Sep. 27, 2018

(54) GLASS MANUFACTURING METHOD

(71) Applicant: ASAHI GLASS COMPANY, LIMITED, Chiyoda-Ku (JP)

(72) Inventors: Junji Hori, Tokyo (JP); Makoto Fujii, Tokyo (JP)

(73) Assignee: ASAHI GLASS COMPANY, LIMITED, Chiyoda-Ku (JP)

(21) Appl. No.: 15/992,426

(22) Filed: May 30, 2018

Related U.S. Application Data
(63) Continuation of application No. PCT/JP2016/085432, filed on Nov. 29, 2016.

(30) Foreign Application Priority Data
Dec. 2, 2015 (JP) 2015-235661

(51) Int. Cl. C03C 15/00; C03C 21/00; C03B 27/04; C03C 19/00; C03B 23/023; C03B 33/02; C03C 17/32; C03C 17/00

(52) U.S. Cl. CPC C03C 15/00; C03C 21/002; C03B 27/04; C03C 19/00; C03B 23/023; C03C 2218/112; C03C 17/32; C03C 17/002; C03C 2217/732; C03C 2217/76; C03B 33/02

(57) ABSTRACT

A glass manufacturing method includes an antiglare layer forming step of forming an antiglare layer on a glass blank, a dimension adjusting step of cutting the glass blank having formed thereon the antiglare layer to obtain a glass substrate, and a strengthening treatment step of strengthening the obtained glass substrate.

### TECHNICAL FIELD

The present invention relates to a glass manufacturing method.

### BACKGROUND ART

Various methods for manufacturing a glass structure having formed on a surface thereof an antiglare layer have been heretofore proposed (see, for example, Patent Document 1). A glass structure having formed thereon an antiglare layer is provided at the front of an image display device (e.g., liquid crystal display, organic EL display) provided on various devices and prevents reflection of sunlight or indoor illumination light on a display surface. In addition, the antiglare layer-attached glass structure is also used for a device other than the above-described image display device. The antiglare layer is generally formed on a glass substrate obtained as a small piece after a glass blank manufactured by a glass molding process is cut into a glass substrate of a desired size.

### PRIOR ART LITERATURE

### Patent Document

Patent Document 1: International Publication No. 2015/133346

### SUMMARY OF THE INVENTION

### Problems that the Invention is to Solve

Meanwhile, when an antiglare layer is separately formed on individual small-piece glass substrates, a film thickness or property may differ for each glass structure due to difference, etc. of the conditions in the forming process. In this case, there arises a difference in the antiglare effect for each glass structure. In particular, when a plurality of sheets of antiglare layer-attached structure are arranged side by side, the difference in the antiglare effect for each glass structure is prominently visible. For example, in the case of disposing a plurality of antiglare layer-attached glass structures in the cabin of an automobile, respective glass structures may not provide a given antiglare effect to deteriorate the visual quality.

In this way, variation in the antiglare layer, which had not been recognized in the case of using one sheet of antiglare layer-attached glass structure alone, appears conspicuously when using a plurality of sheets of antiglare layer-attached glass structure at the same time, giving rise to a problem of reduction in the product quality. It may be conceived to make the conditions in the antiglare layer forming process constant with high accuracy, but this is not realistic, because not only equipment therefor is required but also the process is complicated.

Accordingly, an object of the present invention is to provide a glass manufacturing method where the antiglare effect of a glass having an antiglare layer can be easily uniformized with high accuracy compared to a conventional glass.

### Means for Solving the Problems

The glass manufacturing method of the present invention includes an antiglare layer forming step of forming an antiglare layer on a glass blank, a dimension adjusting step of cutting the glass blank having formed thereon the antiglare layer to obtain a glass substrate, and a strengthening treatment step of strengthening the obtained glass substrate.

### Advantage of the Invention

According to the present invention, the antiglare effect of a glass having an antiglare layer can be easily uniformized with high accuracy compared to a conventional glass.

### BRIEF DESCRIPTION OF THE DRAWINGS

FIG. 1 is a flow chart illustrating basic steps of the glass manufacturing method.

FIG. 2 is a cross-sectional view of a glass structure where an antiglare layer is formed by the glass manufacturing method.

FIG. 3 is a flow chart illustrating a basic configuration of the first manufacturing process.

FIG. 4 is a flow chart illustrating a basic configuration of the second manufacturing process.

FIG. 5A is a flow chart illustrating a first modification example where a finish processing step is added after the molding step of the second manufacturing process.

FIG. 5B is a flow chart illustrating a second modification example where a finish processing step is added before the molding step of the second manufacturing process.

FIG. 6 is a flow chart illustrating a third modification example where a functional layer forming step is added after the strengthening treatment step of the first manufacturing process.

FIG. 7 is a flow chart illustrating a fourth modification example where a functional layer forming step is added after the strengthening treatment step of the second manufacturing process.

FIG. 8A is a flow chart illustrating a fifth modification example where a finish processing step is added to the fourth modification example.

FIG. 8B is a flow chart illustrating a sixth modification example where a finish processing step is added to the fourth modification example.

FIG. 9 is a flow chart illustrating a seventh modification example where a printing step of forming a printed layer is added after the dimension adjusting step of the third modification example.

### MODE FOR CARRYING OUT THE INVENTION

The embodiments of the present invention are described in detail below by referring to the drawings.

First, the basic steps of the glass manufacturing method for manufacturing a glass structure where an antiglare layer is formed are described. The antiglare layer-attached glass produced by the present glass manufacturing method is not particularly limited in its application but may be used for a member of carriers such as automobile, train, ship and aircraft, particularly for an interior member, and may also be used for a cover glass of a mobile personal computer, a mobile phone, a smartphone, etc. For example, the glass can be suitably applied to automotive interior parts such as installment panel, dashboard, center console and shift knob. In this case, high design property or high-class feel can be imparted even to an interior member for carriers in the application where a large and, as the situation demands, complicated shape is required.

### <Basic Steps>

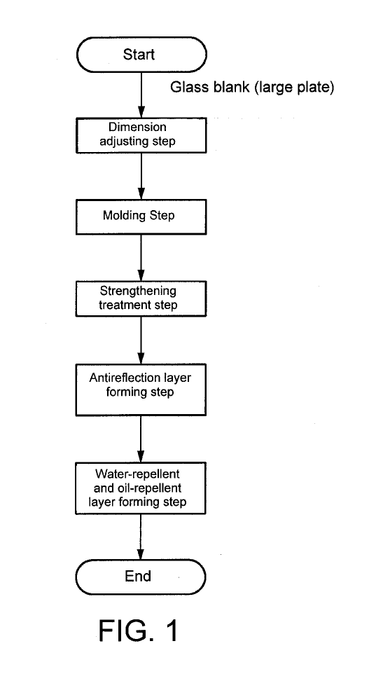

FIG. 1 is a flow chart illustrating basic steps of the glass manufacturing method. As illustrated in the figure, first, a glass substrate having a peripheral shape processed into a substantially product shape is obtained from a prepared glass blank (large plate) (dimension adjusting step). The glass substrate after being processed is, if desired, softened by heating and molded by bending to obtain a glass molded body (molding step). Thereafter, a strengthening treatment for increasing the strength of the glass substrate or glass molded body is performed (strengthening treatment step), an antireflection layer is formed, if desired, on a surface of the glass substrate or glass molded body (antireflection layer forming step), and furthermore, a water-repellent and oil-repellent layer is formed, if desired, on a final surface of the glass substrate or glass molded body (water-repellent and oil-repellent layer forming step).

The above-described series of steps are core steps where the order of steps is not changed. The molding step is conducted before or after conducting the dimension adjusting step from a large plate in the case of producing a glass structure for providing a final product with a curved shape and is omitted in the case of producing a planar glass structure. Into the core steps above, an antiglare layer forming step of forming an antiglare layer, a finish processing step of processing the peripheral shape into a final product shape, and a printing step of forming a printed layer are appropriately incorporated according to the properties of the product.

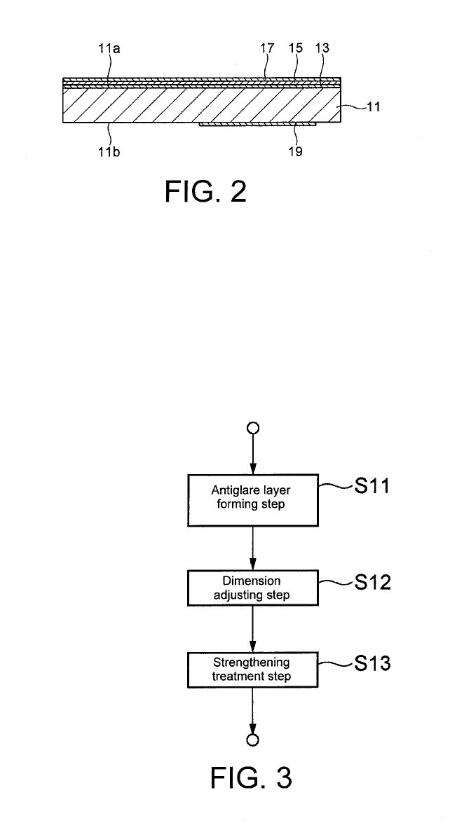

FIG. 2 is a cross-sectional view of a glass structure where an antiglare layer is formed by the glass manufacturing method above. An antiglare layer 13 is formed on a first surface (primary surface) 11a of the glass substrate 11 of the glass structure. In addition, although not illustrated, an antiglare layer 13 may be formed also on a second surface (secondary surface) 11b opposite the first surface 11a of the glass substrate 11. An antireflection layer 15 and a water-repellent and oil-repellent layer 17 are formed in this order on a top surface of the antiglare layer 13. Furthermore, a printed layer 19 is formed on the second surface 11b of the glass substrate 11. The glass structure illustrated in FIG. 2 is in a planar shape, but the entire surface or part of the glass structure may be molded to provide a curved shape by the molding step above.

Next, details of the glass blank and respective steps above are described in sequence.

### <Glass Blank>

The “glass blank” as used in the present description means a planar glass obtained by the glass manufacturing process. The planar glass manufacturing method includes, for example, a float method, a press method, a fusion method, a down draw method, and a rollout method. The glass manufacturing method used in this embodiment is preferably a float method suited for mass production. In addition, a continuous molding method other than the float method, that is, a fusion method or a down draw method, is also preferred. A planer glass member obtained by such a manufacturing method and gradually cooled is the “glass blank”. The glass blank may be used as it is but may also be used after cutting it into a desired size by the later-described method. Furthermore, a glass blank obtained by conducting a polishing step or a chamfering step may also be used.

A planar view size of the glass blank is not limited. For example, a planar-view rectangular glass having a long side of 20 to 3,000 mm may be used. The shape of the glass blank need not be rectangular but may be circular or triangular and is not particularly limited.

A lower limit of the thickness of the glass blank is preferably 0.5 mm or more, more preferably 0.7 mm or more. An upper limit of the thickness of the glass blank is preferably is preferably 5 mm or less, more preferably 3 mm or less, still more preferably 2 mm or less. Within this range, a strength high enough to resist cracking is obtained in the final product and when used for a touch panel, etc., the sensing sensitivity is improved.

As to a glass composition constituting the glass blank of this embodiment, for example, soda lime glass, aluminosilicate glass, aluminoborosilicate glass, and lithium disilicate glass can be used. An example of the preferable composition range is described below. Examples of the glass include a glass containing, as represented by mole percentage based on oxides, from 50 to 79% of SiO₂, from 0.5 to 25% of Al₂O₃, from 0 to 10% of P₂O₅, from 0 to 27% of Na₂O, from 0 to 25% of Li₂O, a total of 4 to 27% of Na₂O and Li₂O, from 0 to 10% of K₂O, from 0 to 18% of MgO, from 0 to 5% of ZrO₂, from 0 to 5% of ZnO, from 0 to 9% of CaO, from 0 to 5% of SrO, from 0 to 10% of BaO, from 0 to 16% of B₂O₃, and from 0 to 7% of a coloring component (a metal oxide of Co, Mn, Fe, Ni, Cu, Cr, V, Bi, Se, Ti, Ce, Er, or Nd). The above-described range is an example and should not be construed to particularly limit the contents of the present invention.

### <Antiglare Layer Forming Step>

The antiglare layer treatment method (hereinafter, sometimes referred to as antiglare treatment) is not particularly limited as long as it is a method enabling formation of a concave/convex shape capable of imparting an antiglare property, and a known method may be used. As the antiglare layer treatment method, for example, a method of applying a surface treatment to at least part of at least one of the first surface and the second surface of the glass blank by a chemical or physical method to form a concave/convex shape having a desired surface roughness can be used. In addition, as the antiglare layer treatment method, a coating solution for the antiglare layer may be applied to or sprayed on at least one of the first surface and the second surface of the glass blank to deposit an antiglare layer on the glass blank and thereby impart a concave/convex shape.

The antiglare treatment by a chemical method includes, specifically, a method of applying a frost treatment. The frost treatment is, for example, a treatment of effecting the etching by immersing the glass blank as a to-be-treated body in a mixed solution of hydrogen fluoride and ammonium fluoride.

In addition, as the antiglare treatment by a physical method, for example, a so-called sand blast treatment of blowing a crystalline silicon dioxide power, a silicon carbide powder, etc. onto a surface of the glass blank with pressurized air, or a method of wetting a brush having attached thereto a crystalline silicon dioxide powder, a silicon carbide powder, etc. with water and polishing a surface of the glass blank by use of the brush, can be employed.

Among these, the frost treatment that is a chemical surface treatment can be favorably used, because the surface of the to-be-treated body is less prone to generation of microcracks and reduction in the strength of the glass blank hardly occurs.

Furthermore, an etching treatment is preferably conducted on at least one principal surface of the glass blank subjected to an antiglare treatment, so as to control the surface profile thereof. As the etching treatment, for example, a method of effecting chemical etching by immersing the glass blank in an aqueous hydrogen fluoride solution as an etching solution may be used. The etching solution may contain an acid such as hydrochloric acid, nitric acid or citric acid, in addition to hydrogen fluoride. When such an acid is contained in the etching solution, local precipitate generation due to a reaction of a cation component such as Na ion and K ion contained in the glass blank with hydrogen fluoride can be suppressed and moreover, the etching can be caused to proceed uniformly within the treatment surface.

In the case of performing an etching treatment, the etching amount is adjusted, for example, by controlling the concentration of etching solution or the immersing time of glass blank in the etching solution, and the haze of the antiglare treatment surface of the glass blank can thereby be adjusted to a desired value. In addition, when the antiglare treatment is performed by a physical surface treatment such as sand blast treatment, cracks are sometimes generated, but even in this case, such cracks can be eliminated by the etching treatment. Furthermore, an effect of reducing glare of the glass blank subjected to an antifouling treatment is also obtained by the etching treatment.

In a region where the antiglare treatment of the glass blank is formed, the average haze of a measurement region is preferably 40% or less, more preferably 30% or less, still more preferably 20% or less. When the haze is 40% or less, reduction in the contrast can be sufficiently suppressed.

As the method to apply a coating solution for the antiglare layer, a known wet coating method (e.g., spray coating method, electrostatic coating method, spin coating method, dip coating method, die coating method, curtain coating method, screen coating method, inkjet method, flow coating method, gravure coating method, bar coating method, flexographic coating method, slit coating method, roll coating method), etc. may be used.

Among these, a spray coating method or an electrostatic coating method (electrostatic spraying method) (the spray coating method and the electrostatic coating method are collectively referred to as a spraying method) is an excellent method for depositing the antiglare layer. When the glass blank is treated with a coating solution for the antiglare layer by using a spray device, an antiglare layer can be formed and an antiglare treatment of the glass blank can be achieved. According to the spray coating method, the haze, etc. can be varied over a wide range. Because, a concave/convex shape necessary for obtaining the required properties can be easily produced by freely changing the amount of the coating solution applied and the material configuration. In particular, the electrostatic coating method (electrostatic spraying method) can be more favorably utilized in the step of forming an antiglare layer on a glass surface of this embodiment. In the case of forming by the electrostatic coating method, uniformity of the antiglare layer within the glass plane is enhanced and despite a large area, a homogeneous film can be formed. In addition, excellent uniformity can be imparted to the outer appearance of the antiglare layer

The coating solution may contain a particle. As the particle, a metal oxide particle, a metal particle, a pigment-based particle, a resin-based particle, etc. may be used.

Examples of the material for the metal oxide particle include Al₂O₃, SiO₂, SnO₂, TiO₂, ZrO₂, ZnO, CeO₂, Sb-containing SnOx (ATO), Sn-containing In₂O₃ (ITO), RuO₂, etc. Of these, SiO₂ is preferred, because its refractive index is the same as that of the matrix.

Examples of the material for the metal particle include a metal (e.g., Ag, Ru), an alloy (e.g., AgPd, RuAu), etc.

Examples of the organic-based particle include an inorganic pigment (e.g., titanium black, carbon black) and an organic pigment.

Examples of the material for the resin particle include an acrylic resin, a polystyrene, a melamine resin, etc.

Examples of a shape of the particle include scaly, spherical, oval, needle-like, platy, bar-like, conical, columnar, cubic, rectangular parallelepiped, diamond-like, star-like, and amorphous shapes, etc. As for other particles, each particle may be present independently from each other, respective particles may be connected like a chain, or respective particles may be aggregated.

The particle may be a solid particle, a hollow particle, or a perforated particle such as a porous particle.

Examples of the scaly particle include a scaly silica particle, a scaly alumina particle, scaly titania, scaly zirconia, etc., and for the reason that a rise of the refractive index of the film can be suppressed and the reflectance can be decreased, a scaly silica particle is preferred.

As other particles, a silica particle such as spherical silica particle, bar-like silica particle and needle-like silica particle is preferred. Among these, for the reason that the haze of the antiglare-attached substrate sufficiently increases and the 60° specular gloss on the surface of the antiglare film sufficiently decreases, consequently sufficiently exerting the antiglare effect, a spherical silica particle is preferred, and a porous spherical silica particle is more preferred.

In the electrostatic coating method, an antiglare layer coating solution is electrically charged and sprayed by using an electrostatic coating apparatus equipped with an electrostatic coating gun. The liquid droplet of the antiglare layer coating solution sprayed from the electrostatic coating gun is negatively charged and therefore, is attracted toward the grounded glass blank by an electrostatic attractive force. Accordingly, the liquid droplet efficiently attaches onto the glass blank, compared with a case of being sprayed without electrical charge. In addition, since an electrostatic force is utilized, when an antiglare property is formed on the glass structure after molding, an antiglare layer that is uniform within the plane can be formed. Consequently, an antiglare layer having excellent aesthetic appearance, homogeneous outer appearance, and high antiglare performance can be formed.

After coating the glass blank with the coating solution, a firing step is conducted. A firing temperature is preferably 200° C. or more, more preferably 300° C. or more, still more preferably 400° C. or more. By this firing, an antiglare film with high film strength can be formed, and the durability of the glass structure as the final product can be enhanced.

As for the antiglare treatment method, one method may be performed alone, or two or more methods may be performed in combination. For example, an etching treatment and an antiglare treatment by a spraying method, etc. using a coating solution are usually conducted individually but may be used in combination.

Before performing the antiglare layer forming step, a step of washing the glass substrate or glass molded body may be performed. For example, in addition to water washing, an acid treatment, an alkali treatment, an alkaline brush washing, or washing using a cleaning solution containing an abrasive such as cerium oxide, may be conducted as the washing step.

### <Dimension Adjusting Step of Glass Blank (Production of Glass Substrate)>

The dimension adjusting processing step is a step of processing the glass blank into a size necessary for conducting the next step to obtain a glass substrate. In the dimension processing step, the glass blank is processed into a size larger than the size required for the final product. Usually, the glass blank is processed into a size larger by approximately from 1 to 100 mm than the size of the final product. The size set to be larger is preferably from 2 to 50 mm, more preferably from 3 to 20 mm, still more preferably from 3 to 10 mm.

Examples of the means for dimension adjusting processing include, for example, a cutter scribing system, a laser cutting system, a water jet system, and a method using a machining center.

In the cutter scribing system, in the case of cutting out a glass substrate from a glass blank, a cutting line is formed on the glass blank with a cutter, and the glass blank is split by folding along the cutting line. The cut end face of the glass blank split by folding is chamfered by a cutting machine to provide a glass substrate of a desired shape. For the cutter, a diamond cutter, etc. can be used.

In the water jet system, unlike the cutter scribing system or laser cutting system, a folding splitting step is not required and therefore, cutting of the blank can be simply and easily performed. Compared with the water jet system or laser cutting system, the cutter scribing system is excellent in view of equipment cost, maintenance cost and running cost and therefore, can be more favorably used.

### <Strengthening Treatment Step>

As the representative strengthening treatment method for forming a compressive stress layer in the glass substrate or glass molded body (after molding into a curved shape), an air cooling tempering method (physical strengthening method) and a chemical strengthening method are known. The air cooling tempering method (physical strengthening method) is a technique where the principal surface of a glass substrate heated to near the softening point is rapidly cooled by air cooling, etc. The chemical strengthening method is a technique where the glass substrate is immersed in a molten potassium nitrate salt at a temperature of not more than the glass transition temperature to effect ion exchanging and an alkali metal ion having a small ion radius (typically Li ion or Na ion) present in the principal surface of the glass substrate is thereby exchanged with an alkali ion having a larger ion radius (typically Na or K ion for Li ion, and K ion for Na ion). In general, a molten potassium nitrate salt is used, but a mixed molten salt having mixed therein potassium carbonate, etc. may also be used.

The principal surface of the glass in the glass substrate or glass molded body for use in this embodiment is subjected to a strengthening treatment and therefore, a glass having high mechanical strength is obtained. In this embodiment, any strengthening technique may be employed, but in the case of obtaining a glass having a thin thickness and a large compressive stress (CS) value, the strengthening is preferably performed by the chemical strengthening method.

The strengthening properties (strengthening profile) of a chemically strengthened glass are generally expressed by the compressive stress (CS; Compressive stress) formed in the surface, the depth of the compressive stress layer (DOL; Depth of layer), and the tensile stress formed inside (CT: Central tension). In the following, the glass substrate or glass molded body is described by taking, as an example, the case where it is a chemically strengthened glass.

In the glass substrate or glass molded body for use in the present invention, a compressive stress layer is formed in the principal surface of the glass. The compressive stress (CS) of the compressive stress layer is preferably 500 MPa or more, more preferably 550 MPa or more, still more preferably 600 MPa or more, yet still more preferably 700 MPa or more. As the compressive stress (CS) is higher, the mechanical strength of the strengthened glass is higher. On the other hand, if the compressive stress (CS) is too high, the tensile stress inside the glass may be increased extremely. For this reason, the compressive stress (CS) is preferably 1,800 MPa or less, more preferably 1,500 MPa or less, still more preferably 1,200 MPa or less.

The depth of the surface compressive stress layer (DOL) formed in the principal surface of the glass substrate or glass molded body is preferably 5 μm or more, more preferably 8 μm or more, still more preferably 10 μm or more. On the other hand, if the DOL is too large, the tensile stress inside the glass may be increased extremely. For this reason, the depth of the compressive stress layer (DOL) is preferably 70 μm or less, more preferably 50 μm or less, still more preferably 40 μm or less, and is typically 30 μm or less.

The compressive stress (CS) formed in the principal surface of the glass substrate or glass molded body and the depth of the surface compressive stress layer (DOL) are determined by observing the number of interference fringes and the interval thereof with a surface stress meter (manufactured by Orihara Manufacturing Co., Ltd., FSM-6000). For example, a light source having a wavelength of 589 nm or 790 nm can be used as the measurement light source of FSM-6000. The surface compressive stress may also be measured using birefringence. When optical evaluation is difficult, estimation can be made using mechanical strength evaluation of three-point bending, etc. In addition, the tensile stress (CT; unit: MPa) formed inside the glass substrate or glass molded body can be calculated according to the following formula by using the compressive stress (CS; unit: MPa) and the depth of the surface compressive stress layer (DOL; unit: μm) measured above.

CT={CS×(DOL×10⁻³)}/{t−2×(DOL×10⁻³)}

In the formula, t (unit: mm) is the sheet thickness of the glass substrate.

The chemically strengthened glass of this embodiment preferably has, in the surface thereof, at least one ion selected from the group consisting of sodium ion, silver ion, potassium ion, cesium ion, and rubidium ion. By containing such an ion, the compressive stress is induced in the surface, and the glass is highly strengthened. In addition, when silver nitrate is mixed with potassium nitrate at the time of chemical strengthening, the glass substrate or glass molded body comes to have silver ion in the surface resulting from ion exchange, and an antibacterial property can be imparted.

After performing the strengthening treatment step, a step of washing the glass substrate or glass molded body may be performed. For example, in addition to water washing, an acid treatment, an alkali treatment, or an alkaline brush washing may be conducted as the washing step. The strengthening treatment step need not be a one time step but may be conducted two or more times under different temperature conditions, time conditions, molten salt composition conditions, etc.

### <Molding Step>

As the molding method used in this embodiment, a desired molding method can be selected from a differential pressure molding method (e.g., vacuum molding method, pressure molding method), a gravity molding method, a press molding method, etc. according to the shape of the glass molded body after molding.

The differential pressure molding method is a method where a differential pressure is given to the front and back surfaces of the glass substrate in the softened state and the glass substrate is bent to conform to the mold and thereby molded into a predetermined shape. In the vacuum molding method, the glass is disposed on a predetermined mold according to the shape of the glass molded body after molding, a clamp mold is disposed on the disposed glass, the periphery of the glass is sealed and a space between the mold and the glass is then evacuated with a pump to thereby give a differential pressure to the front and back surfaces of the glass. In the pressure molding method, the glass is disposed on a predetermined mold according to the shape of the glass molded body after molding, a clamp mold is disposed on the glass, the periphery of the glass is sealed, and a pressure is then applied to the top surface of the glass substrate with compressed air to thereby give a differential pressure to the front and back surfaces of the glass. The vacuum molding method and the pressure molding method may be conducted in combination with each other.

The gravity molding method is a method where a glass is disposed on a predetermined mold according to the shape of the glass molded body after molding and the glass is then softened and caused to gravitationally bend and conform to the mold, thereby molding the glass into the predetermined shape.

The press molding method is a method where a glass is disposed between predetermined mold halves (lower half and upper half) according to the shape of the glass molded body after molding, a pressing load is applied between the upper and lower mold halves while keeping the glass in a softened state, and the glass is thus caused to bend and conform to the mold, thereby molding the glass into the predetermined shape.

Of these molding methods, the differential pressure molding method and the gravity molding method are particularly preferable as the method for obtaining a glass molded body. According to the differential pressure molding method, when the second surface out of the first surface and the second surface of the glass molded body (glass substrate) is caused to serve as the contact surface with the molding die, the glass can be molded without putting the first surface into contact with the molding die, and a concave/convex defect such as damage and dent can therefore be decreased. For this reason, from the viewpoint of enhancing visibility, the first surface is preferably used as the surface on the outer side of an assembly, i.e., the surface with which the user is put in touch in a normal use state.

Two or more molding methods out of the above-described molding methods may be used in combination according to the shape of the glass molded body after molding.

Before the molding step, a step of washing the glass substrate may be performed. By this step, a defect, etc. attached to the glass substrate can be removed, and defects in the obtained glass molded body can be decreased. After the molding step, the glass substrate having formed therein a glass molded body may be washed. A dust generated from the molding die used in the molding step may attach to the glass substrate and damage the glass substrate, but the dust attached can be removed by washing, and generation of a damage can be suppressed. For example, in addition to water washing, an acid treatment, an alkali treatment, or an alkaline brush washing may be conducted as the washing step.

### <Finish Processing Step>

The finish processing step means, for example, a step of adjusting the glass substrate to a size necessary for the next step, cutting out a glass molded body from the glass substrate having formed thereon a plurality of glass molded bodies, or adjusting the glass molded body to a standard size of the final product, and indicates mainly cutting and grinding/chamfering.

In the cutting, for example, an excess edge of the glass molded body obtained by molding the glass substrate is cut to adjust the outer appearance and dimension. In addition, the glass substrate is generally abutted by a pusher, a mold, etc. at a high temperature during molding into a desired shape, and therefore, a defect, etc. is produced on the surface of the glass molded body. Accordingly, molding is performed using a slightly larger glass, a region abutted by a pusher, etc. is removed by cutting, and a glass molded body with little defects is thereby obtained.

In the grinding/chamfering, the end face of the glass substrate or glass molded body, etc. is first processed by a rough grinding stone and then gradually processed by a fine grinding stone. As the material for the rough grinding stone, alumina, cBN (cubic boron nitride), diamond, etc. can be used, and in view of grindability and hardness, the material is preferably diamond. The roughness of the rough grinding stone is preferably from #80 to #500, more preferably from #200 to #400. As the material for the fine grinding stone, alumina, cBN, diamond, etc. can be used, and in view of grindability and hardness, the material is preferably diamond. The roughness of the fine grinding stone is preferably from #300 to #3000, more preferably from #400 to #1200.

At the time of chamfering of the glass substrate or glass molded body, the processing is performed while supplying a coolant (water-soluble grinding liquid) to the processing part. As the coolant, a commercially available product may be appropriately selected and used.

The finish processing step is not limited to cutting or grinding/chamfering, but a polishing step may be conducted on any surface, and the end face may be etched. A perforation step may be conducted on the glass substrate.

After the finish processing step, a step of washing the glass substrate or glass molded body may be performed. By this step, an abrasive, etc. attached to the glass can be removed, and a washing mark can be prevented from remaining on the glass surface. For example, in addition to water washing, an acid treatment, an alkali treatment, an alkaline brush washing, or a washing using a cleaning solution containing an abrasive such as cerium oxide, may be conducted as the washing step.

After the finish processing step, the glass substrate or glass molded body is preferably stored in a liquid, and the liquid is preferably water. By this storage, an abrasive, etc. is not attached to the glass, and a washing mark, etc. can be prevented from remaining on the glass surface.

### <Printing Step>

A printed layer may be formed using various printing methods and inks (printing material) according to usage. As the printing method, for example, spray printing, inkjet printing, and screen printing are utilized. By such a method, good printing can be achieved even on a large-area glass substrate. Above all, in the spray printing or inkjet printing, printing on a glass substrate having a curvature part is facilitated, and the surface roughness of the printed surface is easily controlled. On the other hand, in the screen printing, a desired print pattern is readily formed on a broad glass substrate to afford a uniform average thickness. In addition, a plurality of inks may be used, but in view of adhesiveness of the printed layer, the inks are preferably the same ink.

The ink for forming the printed layer in this embodiment may be organic or inorganic. The inorganic ink may be, for example, any of the compositions containing one or more members selected from SiO₂, ZnO, B₂O₃, Bi₂O₃, Li₂O, Na₂O and K₂O, one or more members selected from CuO, Al₂O₃, ZrO₂, SnO₂ and CeO₂, Fe₂O₃, and TiO₂.

As the organic ink, various printing materials prepared by dissolving a resin in a solvent can be used. For example, as the resin, at least one resin may be selected from the group consisting of resins such as acrylic resin, urethane resin, epoxy resin, polyester resin, polyamide resin, vinyl acetate resin, phenolic resin, olefin, ethylene-vinyl acetate copolymer resin, polyvinyl acetal resin, natural rubber, styrene-butadiene copolymer, acryl nitrile-butadiene copolymer, polyester polyol and polyether polyurethane polyol, and used. As the solvent, water, alcohols, esters, ketones, an aromatic hydrocarbon-based solvent or an aliphatic hydrocarbon-based resin may be used. For example, as the alcohols, isopropyl alcohol, methanol, ethanol, etc. may be used; as esters, ethyl acetate may be used; and as ketones, methyl ethyl ketone may be used. In addition, as the aromatic hydrocarbon-based solvent, toluene, xylene, Solvesso 100 and Solvesso 150 produced by Exxon Corp., etc. may be used; and as the aliphatic hydrocarbon-based solvent, hexane, etc. may be used. These are recited as an example, and other various printing materials may be used. The organic printing material above is applied to a transparent plate, the solvent is then vaporized to form a resin layer, and a printed layer is thereby obtained.

In the ink used for the printed layer, a coloring agent may be contained. As the coloring agent, for example, in the case of forming a black printed layer, a black coloring agent such as carbon black may be used. In addition, a coloring agent for an appropriate color according to the desired color may be used.

After the printing step, a step of washing the glass substrate or glass molded body may be performed. By this step, a printing material-derived organic substance, etc. attached to the glass can be removed, and the glass surface can be made clean. For example, in addition to water washing, an acid treatment, an alkali treatment, an alkaline brush washing, or a washing using an organic solvent may be conducted as the washing step. In the washing using an organic solvent, the glass substrate or glass molded body having formed thereon a printed layer may be immersed in an organic solvent and dried, or so-called steam cleaning may be performed.

### <Functional Layer Forming Step>

As a functional layer, an antireflection layer and a water-repellent and oil-repellent layer are described.

### (Antireflection Layer)

The antireflection layer is a layer that produces an effect of reduction in the reflectance, reduces the glare due to reflection of light, and in the case of use for a display device, can increase the transmittance of light from the display device and enhance the visibility of the display device.

The configuration of the antireflection layer is not particularly limited as long as it is a configuration capable of suppressing reflection of light, and, for example, the layer may have a configuration where a high refractive index layer having a refractive index of 1.9 or more at a wavelength of 550 nm and a low refractive index layer having a refractive index of 1.6 or less at a wavelength or 550 nm are laminated.

The antireflection layer may have a configuration containing one high reflective index layer and one low refractive index layer but may also be configured to contain two or more high refractive index layers and two or more low refractive index layers. In the case where the antireflection layer contains two or more high refractive index layers and two or more low refractive index layers, a configuration where a high refractive index layer and a low refractive index layer are alternately laminated is preferred.

In order to increase the antireflection property, the antireflection layer is preferably a laminate where a plurality of layers are laminated. For example, the laminate of the antireflection layer is preferably a lamination of a total of 2 or more and 8 or less layers, more preferably a lamination of 2 or more and 6 or less layers, still more preferably a lamination of 2 or more and 4 or less layers. The laminate as used herein is preferably a laminate where, as described above, a high refractive index layer and a low refractive index layer are laminated, and the total number of respective layers of the high refractive index layer and the low refractive index layer is preferably in the range above.

Materials of the high refractive index layer and the low refractive index layer are not particularly limited and may be appropriately selected by taking into account the required degree of antireflection property, the productivity, etc. As a material constituting the high refractive index layer, for example, one or more members selected from niobium oxide (Nb₂O₅), titanium oxide (TiO₂), zirconium oxide (ZrO₂), tantalum oxide (Ta₂O₅), and silicon nitride (Si₃N₄) may be preferably used. As a material constituting the low refractive index layer, one or more members selected from silicon oxide (SiO₂), a material containing a mixed oxide of Si and Sn, a material containing a mixed oxide of Si and Zr, and a material containing a mixed oxide of Si and Al may be preferably used.

As regards the material of each layer, in view of productivity and refractive index, a configuration where the high refractive index layer is composed of one member selected from niobium oxide, tantalum oxide and silicon nitride and the low refractive index layer is a layer composed of silicon oxide, is preferred.

The method for forming the antireflection layer includes, for example, a method where the layer is applied onto the surface of an adhesion layer formed on the antiglare film or other functional film, by a spin coating method, a dip coating method, a casting method, a slit coating method, a spray coating method, etc. and then heat-treated, if desired; and a method where the layer is deposited on the surface of the adhesion layer by a chemical vapor deposition method (CVD method) or a physical vapor deposition method (PVD method) such as sputtering or PVD method.

### (Water-Repellent and Oil-Repellent Layer)

The water-repellent and oil-repellent layer is a film that prevents attachment of an organic matter or inorganic matter to the surface, or a layer producing an effect that even when an organic matter or inorganic matter is attached to the surface, the attached substance can be easily removed by cleaning such as wiping.

The water-repellent and oil-repellent layer is not particularly limited as long as, for example, an antifouling property can be imparted by having water repellency or oil repellency, but the layer is preferably composed of a fluorine-containing organosilicon compound coat obtained by curing through a hydrolysis and condensation reaction of a fluorine-containing organosilicon compound.

The thickness of the water-repellent and oil-repellent layer is not particularly limited, but in the case where the water-repellent and oil-repellent layer is constituted from a fluorine-containing organosilicon compound coat, the thickness is, in terms of a film thickness, preferably from 2 to 20 nm, more preferably from 2 to 15 nm, still more preferably from 2 to 10 nm. When the film thickness is 2 nm or more, the surface is in a state of being evenly coated with the water-repellent and oil-repellent layer and can withstand practical use in view of abrasion resistance. In addition, when the film thickness is 20 nm or less, the glass molded body after molding has good optical properties.

Examples of the method for forming a fluorine-containing organosilicon compound coat include, a method where a composition of a silane coupling agent having a fluoroalkyl group such as perfluoroalkyl group or perfluoro(polyoxyalkylene) chain-containing fluoroalkyl group is applied onto the surface of an adhesion layer formed on the glass substrate or other functional film, by a spin coating method, a dip coating method, a casting method, a slit coating method, a spray coating method, etc. and then heat-treated, if desired; and a vacuum deposition method where a fluorine-containing organosilicon compound is vapor-deposited on the surface of the adhesion layer and then heat-treated, if desired. In order to obtain a fluorine-containing organosilicon compound coat having high adhesiveness, the coat is preferably formed by the vacuum deposition method. Formation of a fluorine-containing organosilicon compound coat by the vapor deposition method is preferably conducted using a coat-forming composition containing a fluorine-containing hydrolyzable silicon compound.

The coat-forming composition is not particularly limited as long as it is a composition containing a fluorine-containing hydrolyzable silicon compound and the composition can form a coat by the vapor deposition method. The coat-forming composition may contain an optional component other than the fluorine-containing hydrolyzable silicon compound or may be constituted only from a fluorine-containing hydrolyzable silicon compound. The optional component includes a hydrolyzable silicon compound having no fluorine atom (hereinafter, referred to as “fluorine-free hydrolyzable silicon compound”), a catalyst, etc., which are used to an extent not compromising the effects of the present invention.

In blending a fluorine-containing hydrolyzable silicon compound and an optional fluorine-free hydrolyzable silicon compound with the coat-forming composition, each compound may be blended as it is or may be blended as a partial hydrolysis condensate thereof. The compound may also be blended as a mixture of the compound and a partial hydrolysis condensate thereof with the coat-forming composition.

In the case of using two or more hydrolyzable silicon compounds in combination, each compound may be blended as it is with the coat-forming composition, may be blended as a partial hydrolysis condensate thereof, or furthermore, may be blended as a partial hydrolysis condensate of two or more compounds. In addition, these compounds may also be a mixture with a partial hydrolysis condensate and a partial hydrolysis co-condensate. However, the partial hydrolysis condensate and partial hydrolysis co-condensate used should have a polymerization degree of a level enabling vacuum deposition. Hereinafter, the term “hydrolyzable silicon compound” is used in the sense of encompassing such partial hydrolysis condensate and partial hydrolysis co-condensate, in addition the compound itself.

The fluorine-containing hydrolyzable silicon compound used for forming the fluorine-containing organosilicon compound coat of this embodiment is not particularly limited as long as the obtained fluorine-containing organosilicon compound coat has an antifouling property such as water repellency and oil repellency.

Specifically, Examples of the compound include a fluorine-containing hydrolyzable silicon compound having one or more groups selected from the group consisting of a perfluoropolyether group, a perfluoroalkylene group and a perfluoroalkyl group. Such a group is present as a fluorine-containing organic group bonded to the silicon atom of a hydrolyzable silyl group either via a linking group or directly. As the commercially available fluorine-containing organosilicon compound having one or more groups selected from the group consisting of a perfluoropolyether group, a perfluoroalkylene group and a perfluoroalkyl group (fluorine-containing hydrolyzable silicon compound), AFLUID (registered trademark) S-550 (trade name, produced by Asahi Glass Co., Ltd.), etc. can be preferably used.

In the case where the commercially available fluorine-containing hydrolyzable silicon compound is supplied together with a solvent, the compound is used after removing the solvent. The coat-forming composition used in this embodiment is prepared by mixing the above-described fluorine-containing hydrolyzable silicon compound and an optional component added, if desired, and used for vacuum deposition.

A coat-forming composition containing such a fluorine-containing hydrolyzable silicon compound is adhered to the surface of the adhesion layer and deposited through a reaction, and a fluorine-containing organosilicon compound coat is thereby obtained. As to the specific vacuum deposition method and reaction conditions, conventionally known methods, conditions, etc. can be applied.

Next, each manufacturing process in the glass manufacturing method of the present invention is described.

### <First Manufacturing Process>

FIG. 3 is a flow chart illustrating a basic configuration of the first manufacturing process.

The first manufacturing process is a process of manufacturing a planar glass structure, and an antiglare layer forming step S11 is incorporated into respective steps after removing the molding step from the basic steps illustrated in FIG. 1. That is, in this process, an antiglare layer forming step S11 is conducted before the dimension adjusting step S12. More specifically, in the antiglare layer forming step S11, an antiglare film is formed on the glass blank (large plate) before processing into a glass substrate.

In this case, since antiglare layers are formed at once on the entire surface of the glass blank, the conditions in the process of forming the antiglare layer can be made constant, and a homogeneous antiglare layer is obtained. Consequently, when the glass blank having formed thereon the antiglare layer is cut into small-piece glass substrates in the later dimension adjusting step, among the antiglare layers of respective glass substrates, the property of the antiglare layer becomes uniform, and the antiglare performance is not varied. Accordingly, even when a plurality of sheets of the obtained glass substrate are used at the same time, the difference in the antiglare performance for every glass substrate is small, and each glass can provide an excellent aesthetic appearance.

In the case of forming the antiglare layer by film production, when additives added to the antiglare layer are adjusted, the refractive index control is facilitated. In addition, the haze, glare, etc. can easily be controlled to desired properties. The antiglare layer is preferably formed in particular by an electrostatic coating method. In the case of forming by an electrostatic coating method, the uniformity of the antiglare layer in the glass plane is enhanced, and homogeneous film production can be achieved even in a large area. In the case of forming the antiglare layer by etching, a homogeneous antiglare layer can always be formed by constantly adjusting the etching solution. The etching treatment can therefore be suitably used in the case of mass production at a time.

### <Second Manufacturing Process>

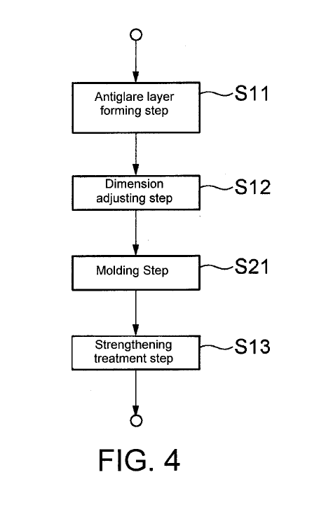

FIG. 4 is a flow chart illustrating a basic configuration of the second manufacturing process.

The second manufacturing process is a process of manufacturing a glass structure having a curved shape, and an antiglare layer forming step S11 is added to the basic steps illustrated in FIG. 1.

In some cases, one sheet of glass blank is divided and while one is used for a planar glass structure, another is used for a glass structure having a curved shape. On this occasion, even when a planar glass structure and a glass structure having a curved shape, which are dividedly manufactured, are disposed side by side, the antiglare performance is not varied, and a good outer appearance can be maintained. Consequently, the degree of freedom of the decorative design is increased, and the degree of design freedom of various products using the glass structure can be enhanced.

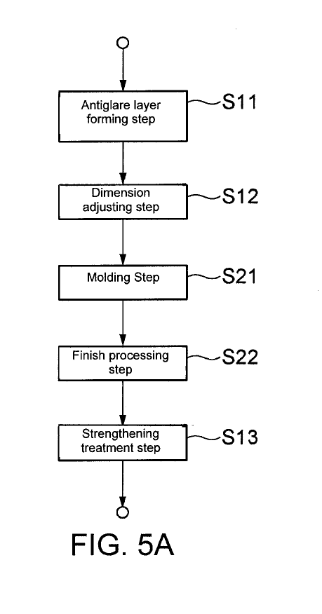

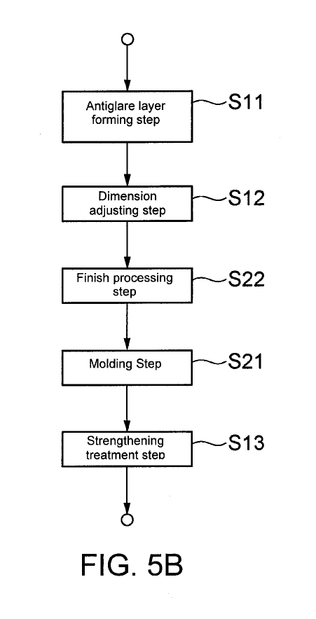

FIG. 5A is a flow chart illustrating a first modification example where a finish processing step S22 is added after the molding step S21 of the second manufacturing process.

In the molding step S21, when a glass substrate is placed on a mold and bending work is forcibly performed with a pusher, a mark of abutting of the pusher remains on the surface of a glass molded body obtained by molding the glass substrate. Even in this case, when the finish processing step S22 is conducted after the molding step S21, the mark generated in the molding step S21 can be removed in the finish processing step. In addition, even when the end face of the glass molded body is deformed by the molding step S21, the deformation does not affect the final shape. Consequently, the surface profile of the glass molded body can maintain an excellent aesthetic appearance. Although description is omitted, the finish processing step S22 may be added not only to the second manufacturing process illustrated in FIG. 4 but also to the first manufacturing process illustrated in FIG. 3 and is preferably conducted after the dimension adjusting step S12.

FIG. 5B is a flow chart illustrating a second modification example where a finish processing step S22 is added before the molding step S21 of the second manufacturing process.

In this case, since finish processing is applied to a planar glass substrate, the processing step is not complicated, and the tact time can be shortened.

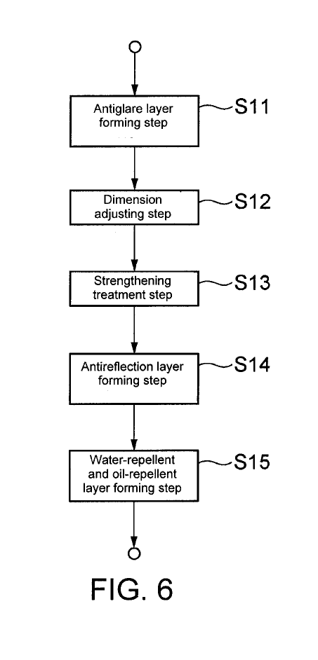

FIG. 6 is a flow chart illustrating a third modification example where a functional layer forming step is added after the strengthening treatment step S13 of the first manufacturing process.

In the functional layer forming step of this modification example, the antireflection layer forming step S14 and the water-repellent and oil-repellent layer forming step S15 are conducted in this order. The functional layer forming step may be a step where out of the antireflection layer forming step S14 and the water-repellent and oil-repellent layer forming step S15, at least either one step is conducted and either an antireflection layer or a water-repellent and oil-repellent layer is formed.

The antireflection layer forming step S14 and the water-repellent and oil-repellent layer forming step S15 are more preferably conducted after the strengthening treatment step S13. By conducting these steps after the strengthening treatment, the glass strengthening effect is not hindered by the antireflection layer and the water-repellent and oil-repellent layer in the strengthening treatment step S13. For example, in the case where the strengthening treatment is a chemical strengthening treatment, exchange of Na ion or K ion, etc. in the glass surface with an alkali ion is inhibited by the presence of each of the layers above. As a result, when each of the layers above is formed on only either one of the principal surface and the secondary surface of the glass substrate or glass molded body, a deviation is produced between the compressive stress of the surface having not formed thereon the layers and the compressive stress of the surface having formed thereon the layers, and warpage occurs in the glass substrate or glass molded body. Furthermore, in the case where each layer is composed of an organic matter, when the glass substrate or glass molded body is heated at a glass transition temperature (typically, about 400° C.) in the strengthening treatment step S13, the organic matter is decomposed. The same holds true for the physical strengthening treatment, and the organic matter is decomposed.

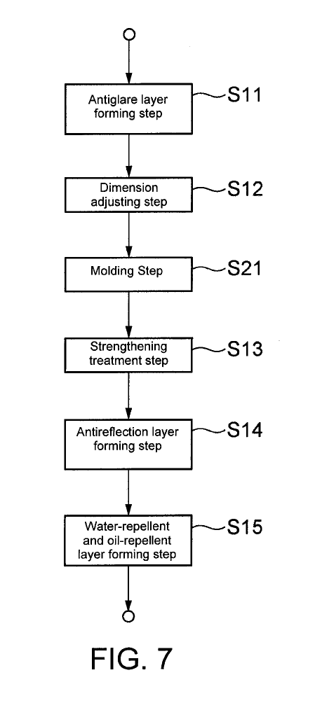

FIG. 7 is a flow chart illustrating a fourth modification example where a functional layer forming step is added after the strengthening treatment step S13 of the second manufacturing process.

In the manufacturing process of this modification example, the antireflection layer forming step S14 and the water-repellent and oil-repellent layer forming step S15 are conducted in this order after the strengthening treatment step S13, but only either one step may be conducted. The same action/effect as in the third modification example is obtained also in this case.

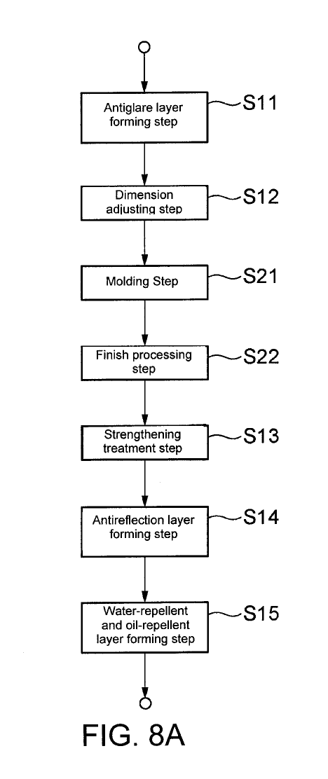

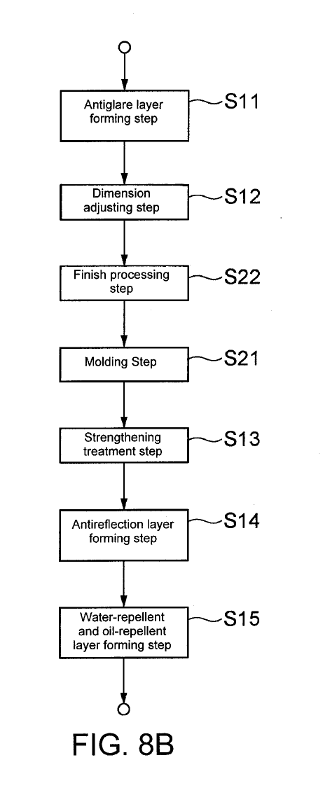

FIG. 8A is a flow chart illustrating a fifth modification example where a finish processing step S22 is added after the molding step S21 of the fourth modification example. FIG. 8B is a flow chart illustrating a sixth modification example where a finish processing step S22 is added before the molding step S21 of the fourth modification example. The same action/effect as in the first modification example and second modification example is obtained also in the fifth and sixth modification examples. Particularly, in the fifth modification example, when a plurality of glass molded bodies are formed in one sheet of the glass substrate, a plurality of glass molded bodies are obtained by one finish processing. Accordingly, this modification example provides a plurality of glass substrates having a uniform outer appearance and is suited for mass production.

In each manufacturing process and each modification example described above, a printing step of forming a printed layer may further be added.

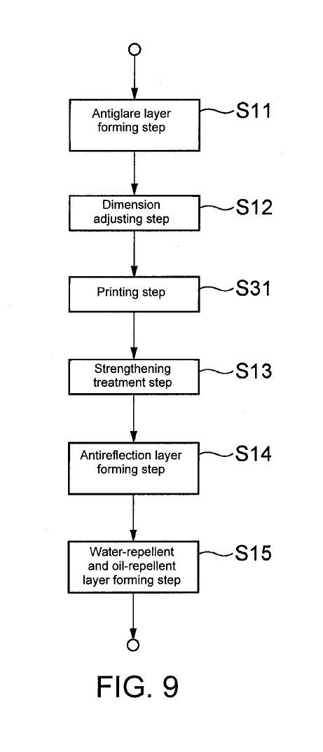

FIG. 9 presented as an example is a flow chart illustrating a seventh modification example where a printing step S31 is added after the dimension adjusting step S12 of the third modification example.

The printing step is preferably conducted at any timing after the dimension adjusting step S12. If the printing step is conducted before the dimension adjusting step, cracking or separation of the printed layer formed may occur at the time of cutting the glass blank, resulting in production of a missing part. Accordingly, the printing step is conducted at an arbitrary timing after the dimension adjusting step S12, and the printed layer can thereby be maintained in the desired shape (pattern) without producing a missing part in the printed layer.

In addition, it is more preferable to conduct the printing step after the strengthening treatment step S13. In this case, the strengthening effect can be prevented from being hindered by the printed layer in the strengthening treatment step S13. For example, in the case where the strengthening treatment is a chemical strengthening treatment, exchange of Na ion or K ion, etc. in the glass surface with an alkali ion is inhibited by the presence of the printed layer. As a result, when the printed layer is formed on only either one of the principal surface and the secondary surface of the glass substrate or glass molded body, a deviation is produced between the compressive stress of the surface having not formed thereon the printed layer and the compressive stress of the surface having formed thereon the printed layer, and warpage occurs in the glass substrate or glass molded body. Furthermore, in the case where the printed layer is composed of an organic matter, when the glass substrate or glass molded body is heated at a glass transition temperature (typically, about 400° C.) in the strengthening treatment step S13, the organic matter is decomposed. The same holds true for the physical strengthening treatment, and the organic matter is decomposed.

The present invention is not limited to the above-described embodiments, and combinations of respective configurations of the embodiments with each other or changes and applications made by one skilled in the art based on the description and known techniques are reserved for the present invention and included in the scope requiring protection.

As described in the foregoing pages, the following matters are disclosed in the present description.

(1) A glass manufacturing method including an antiglare layer forming step of forming an antiglare layer on a glass blank, a dimension adjusting step of cutting the glass blank having formed thereon the antiglare layer to obtain a glass substrate, and a strengthening treatment step of strengthening the obtained glass substrate.

According to this glass manufacturing method, a homogeneous antiglare layer can be formed on the glass blank, and the quality variation among antiglare layers of respective glass substrates can be reduced by cutting and strengthening the glass substrate after the antiglare layer formation. Consequently, the antiglare effect of the glass having an antiglare layer can be uniformized with high accuracy compared to a conventional glass.

(2) The glass manufacturing method according to (1), including a molding step of molding the glass substrate, after the dimension adjusting step but before the strengthening treatment step.

According to this glass manufacturing method, the glass substrate subjected to a strengthening step is prevented from dulling due to heating in the molding step.

(3) The glass manufacturing method according to (1) or (2), including a finish processing step of processing the glass substrate into a final product shape, after the dimension adjusting step but before the strengthening treatment step.

According to this glass manufacturing method, the strengthening-treated layer of the glass substrate is not removed by the finish processing.

(4) The glass manufacturing method according to (3), including a molding step of molding the glass substrate, after the dimension adjusting step but before the strengthening treatment step, wherein

the finish processing step is conducted after the molding step.

According to this glass manufacturing method, the surface profile of the glass substrate can maintain an excellent aesthetic appearance.

(5) The glass manufacturing method according to (4), wherein in the molding step, a plurality of glass molded bodies are formed in one sheet of the glass substrate.

According to this glass manufacturing method, since glass molded bodies including a large number of final product shapes are obtained by once conducting the molding step requiring a long tact time, mass production is facilitated, and efficiency is promoted.

(6) The glass manufacturing method according to (5), wherein in the finish processing step, the glass molded bodies including a plurality of final product shapes, formed in one sheet of the glass substrate, are cut out.

(7) The glass manufacturing method according to (6), wherein in the finish processing step, the glass molded body cut out is chamfered.

According to the glass manufacturing methods of (6) and (7), a glass substrate succeeded in removing a chipping, etc. on the end face and excellent in aesthetic appearance is obtained with high efficiency. In addition, fine cracks, etc. produced in the end face can also be removed, and occurrence of cracking or chipping in the next step can be suppressed.

(8) The glass manufacturing method according to any one of (1) to (7), including a functional layer forming step of forming at least either an antireflection layer or a water-repellent and oil-repellent layer, after the strengthening treatment step.

According to this glass manufacturing method, hindrance to the strengthening treatment, or occurrence of warpage in the glass can be prevented. In addition, decomposition of the antireflection layer or water-repellent and oil-repellent layer can be prevented.

(9) The glass manufacturing method according to any one of (1) to (8), including a printing step of forming a printed layer, after the dimension adjusting step.

According to this glass manufacturing method, the printed layer can be maintained in the desired shape (pattern) without producing a missing part in the printed layer.

(10) The glass manufacturing method according to (9), wherein the printing step is conducted after the strengthening treatment step.

According to this glass manufacturing method, hindrance to the strengthening treatment, or occurrence of warpage in the glass can be prevented. In addition, the printed layer can be prevented from decomposition.

(11) The glass manufacturing method according to any one of (1) to (10), wherein the antiglare layer is formed by deposition.

According to this glass manufacturing method, the refractive index control is facilitated by the adjustment of additives. In addition, the haze, glare, etc. can easily be controlled to desired properties.

(12) The glass manufacturing method according to (11), wherein the deposition is formed by a spraying method.

According to this glass manufacturing method, a uniform antiglare layer can be formed on a large-area glass blank, and a glass substrate or glass molded body having a uniform outer appearance are efficiently obtained.

(13) The glass manufacturing method according to any one of (1) to (10), wherein the antiglare layer is formed by etching.

According to this glass manufacturing method, mass production at a time is facilitated.

This application is based on Japanese Patent Application (Patent Application No. 2015-235661) filed on Dec. 2, 2015, the contents of which are incorporated herein by way of reference.

### DESCRIPTION OF REFERENCE NUMERALS AND SIGNS

11 Glass substrate
13 Antiglare layer
15 Antireflection layer
17 Water-repellent and oil-repellent layer
19 Printed layer

1. A glass manufacturing method comprising: an antiglare layer forming step of forming an antiglare layer on a glass blank; a dimension adjusting step of cutting the glass blank having formed thereon the antiglare layer to obtain a glass substrate; and a strengthening treatment step of strengthening the obtained glass substrate.

2. The glass manufacturing method according to claim 1, comprising a molding step of molding the glass substrate, after the dimension adjusting step but before the strengthening treatment step.

3. The glass manufacturing method according to claim 1, comprising a finish processing step of processing the glass substrate into a final product shape, after the dimension adjusting step but before the strengthening treatment step.

4. The glass manufacturing method according to claim 3, comprising a molding step of molding the glass substrate, after the dimension adjusting step but before the strengthening treatment step, wherein
the finish processing step is conducted after the molding step.

5. The glass manufacturing method according to claim 4, wherein in the molding step, a plurality of glass molded bodies are formed in one sheet of the glass substrate.

6. The glass manufacturing method according to claim 5, wherein in the finish processing step, the glass molded bodies including a plurality of final product shapes, formed in one sheet of the glass substrate, are cut out.

7. The glass manufacturing method according to claim 6, wherein in the finish processing step, the glass molded body cut out is chamfered.

8. The glass manufacturing method according to claim 1, comprising a functional layer forming step of forming at least either an antireflection layer or a water-repellent and oil-repellent layer, after the strengthening treatment step.

9. The glass manufacturing method according to claim 1, comprising a printing step of forming a printed layer, after the dimension adjusting step.

10. The glass manufacturing method according to claim 9, wherein the printing step is conducted after the strengthening treatment step.

11. The glass manufacturing method according to claim 1, wherein the antiglare layer is formed by deposition.

12. The glass manufacturing method according to claim 11, wherein the deposition is formed by a spraying method.

13. The glass manufacturing method according to claim 1, wherein the antiglare layer is formed by etching.
